(19) United States
(12) Patent Application Publication
(10) Pub. No.: US 2022/0263256 A1
(43) Pub. Date: Aug. 18, 2022

(54) METAL ELECTRICAL CONNECTOR FOR FLEXIBLE ELECTRICALLY CONDUCTIVE STRIP AND RELATED CONDUCTIVE STRIP CONNECTOR ASSEMBLY

(71) Applicant: Valeo Systemes Thermiques, Le Mesnil Saint-Denis (FR)

(72) Inventors: Samuel Ahizi, Le Mesnil Saint-Denis (FR); Nicolas Devienne, Le Mesnil Saint-Denis (FR)

(73) Assignee: Valeo Systemes Thermiques, Le Mesnil Saint-Denis (FR)

(21) Appl. No.: 17/627,943

(22) PCT Filed: Jul. 6, 2020
(86) PCT No.: PCT/FR2020/051186

§ 371 Date: Jan. 18, 2022

(30) Foreign Application Priority Data
Jul. 18, 2019 (FR) 1908110

(51) Int. Cl. H01R 4/2407; H01R 4/26; H01R 4/64

(52) U.S. Cl. CPC H01R 4/2407; H01R 4/646; H01R 4/26

(57) ABSTRACT

Metal electrical connector (1) for flexible electrically conductive strip (2) extending along a longitudinal axis (A), said conductive strip (2) comprising: —a flexible support layer (3) comprising a first face and a second face opposite the first face, and —a conductive path (4) arranged on the first face of the flexible support layer (3), said electrical connector (1) comprising: —a base (10) having a generally parallelepiped shape and configured to cover a portion of the conductive strip (2), said base (10) comprising at least one leading edge (101) intended to face the conductive strip (2) perpendicular to the longitudinal axis (A), —connecting teeth (12a, 12b) configured to pass through the conductive path (4) and the flexible support layer (3), —a connecting member (11) projecting from one of the edges of the base (10) other than the leading edge (101), the leading edge (101) of the base (10) having an inwardly curved profile over the width of the base (10).

The present invention relates to a metal electrical connector for a flexible electrically conductive strip, in particular a flexible electrical strip comprising a wide conductive path, that is to say at least 10 mm or more wide. More particularly, this flexible electrically conductive strip is a surface radiant panel with a power that may be greater than or equal to 500 W/m² for a current that may reach 15 A.

The metal electrical connectors of the prior art for a flexible electrically conductive strip are generally suitable for powers and currents of low magnitude, for example of the order of 3 A. In addition, these conductive strips have a narrow conductive path, for example from 2 to 3 mm. For wider conductive strips having a wider conductive path, due to the flexibility of the assembly and the presence of the electrical connector, cracks and breaks may form on the conductive path at the junction with the electrical connector and therefore bring about interruptions in the continuity of electrical conduction and cause regions of high resistance.

In addition, the metal electrical connectors of the prior art are generally bulky and create an overthickness, this being detrimental to the haptic qualities of the conductive strip, in particular when it is a surface radiant panel which is meant to be as discreet as possible.

One of the aims of the present invention is therefore to at least partially remedy the drawbacks of the prior art and to provide an electrical connector for a flexible conductive strip having improved haptic qualities and in which the risk of cracks forming on the conductive path is reduced.

The present invention therefore relates to a metal electrical connector for a flexible electrically conductive strip extending along a longitudinal axis, said conductive strip comprising:
a flexible support layer comprising a first face and a second face opposite the first face, and
a conductive path arranged on the first face of the flexible support layer,
   said electrical connector comprising:
a base having a generally parallelepipedal shape and configured to cover a portion of the conductive strip, said base comprising at least one leading edge intended to face said conductive strip perpendicular to the longitudinal axis,
connecting teeth configured to pass through the conductive path and the flexible support layer,
a connecting member projecting from one of the edges of the base other than the leading edge,
   the leading edge of the base having a profile that is curved over the width of said base.

This curved profile makes it possible to limit the risk of breaks and cracks forming within the conductive path perpendicular to the longitudinal axis of the conductive strip and therefore perpendicular to the direction in which the current flows. This is particularly advantageous for wide conductive paths, that is to say, for example, of a width greater than 5 mm or even greater than 10 mm.

According to one aspect of the invention, the base exhibits increasing flexibility with decreasing distance from the leading edge.

This allows the movements of the conductive strip to be followed and thus the risk of breaks and cracks forming at the leading edge to be limited even more.

According to another aspect of the invention, the base comprises perforations, the concentration of which increases with decreasing distance from the leading edge.

According to another aspect of the invention, the perforations are slots of identical shape to the leading edge and are parallel to said leading edge.

According to another aspect of the invention, the junction between the edges of the base which are contiguous with the leading edge and said leading edge is rounded.

Limiting the sharp angles makes it possible to limit the risk of breaks and cracks forming within the conductive path perpendicular to the longitudinal axis.

According to another aspect of the invention, the electrical connector comprises first connecting teeth, the base of which is intended to be arranged parallel to the longitudinal axis of the conductive strip.

The fact that the base of these first connecting teeth is parallel to the longitudinal axis of the conductive strip makes it possible for the resistance of the conductive path not to be modified, or to be modified only slightly.

According to another aspect of the invention, the base covers at least 90% of the width of the conductive path and the edges of the base which are contiguous with the leading edge each comprise at least one first connecting tooth.

Thus, the electric current is better distributed over the width of the conductive path and the risk of hot spots forming is reduced.

According to another aspect of the invention, the electrical connector comprises second connecting teeth in smaller numbers than the first connecting teeth, the base of which is intended to be arranged perpendicular to the longitudinal axis of the conductive strip.

The role of these second connecting teeth is here mechanical strength and keeping the electrical connector 1 on the conductive strip.

The present invention also relates to an assembly comprising:
a flexible electrically conductive strip extending along a longitudinal axis, said conductive strip comprising a flexible support layer comprising a first face and a second face opposite the first face, and a conductive path arranged on the first face of the flexible support layer, and
an electrical connector as described before, the connecting teeth of which pierce through the support layer and the conductive path of said support layer.

According to another aspect of the assembly according to the invention, an additional flexible layer is arranged between the base of the electrical connector and the conductive strip, the additional flexible layer projecting beyond the leading edge of the electrical connector and being pierced through by the connecting teeth, said additional flexible layer having a flexibility lower than that of the conductive strip.

Due to its flexibility being lower than that of the conductive strip, this additional layer will attenuate the movements of the conductive strip and limit the risk of breaks and cracks forming at the leading edge.

The appended drawings illustrate the invention.

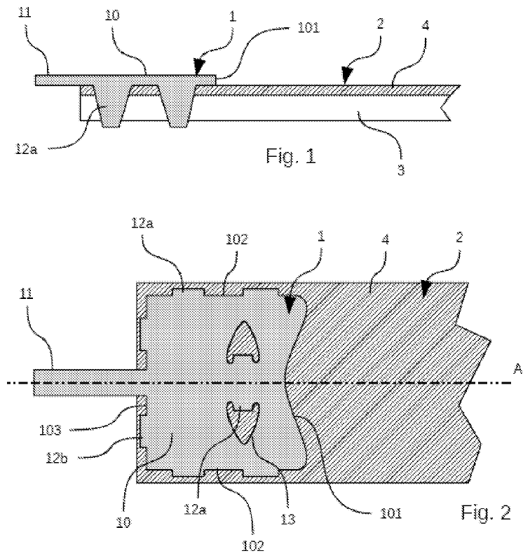

FIG. 1 shows a schematic side view of a conductive strip and of its electrical connector according to a first embodiment.

FIG. 2 shows a schematic top view of the conductive strip and of the electrical connector of FIG. 1.

FIG. 3 shows a schematic bottom view of the conductive strip and of the electrical connector of FIG. 1.

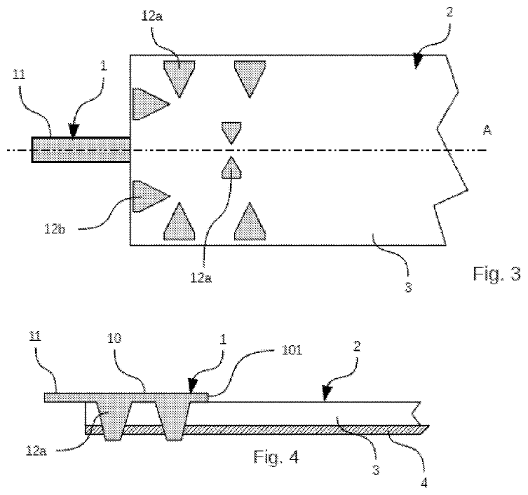

FIG. 4 shows a schematic side view of a conductive strip and of its electrical connector according to a second embodiment.

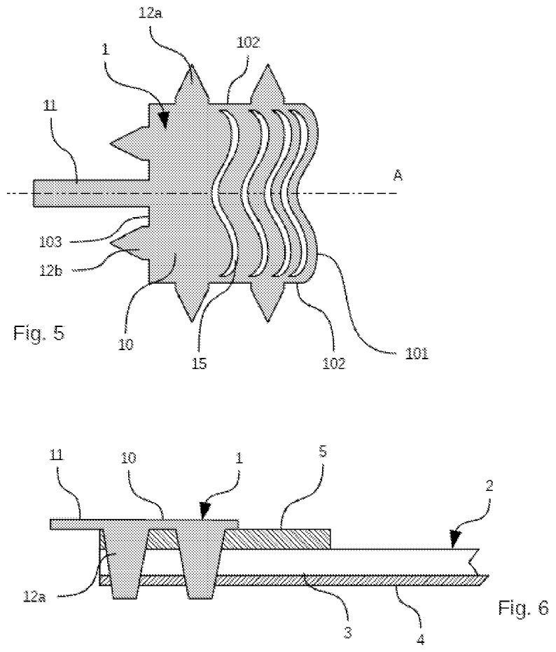

FIG. 5 shows a schematic top view of an electrical connector according to another embodiment.

FIG. 6 shows a schematic side view of a conductive strip and of its electrical connector according to a second embodiment.

In the various figures, identical elements bear the same reference numbers.

The following embodiments are examples. Although the description refers to one or more embodiments, this does not necessarily mean that each reference relates to the same embodiment, or that the features only apply to a single embodiment. Individual features of different embodiments may also be combined and/or interchanged in order to provide other embodiments.

In the present description, some elements or parameters may be indexed, such as, for example, a first element or a second element and a first parameter and a second parameter or even a first criterion and a second criterion, etc. In this case, this is simply indexing for differentiating and denominating elements or parameters or criteria that are similar but not identical. This indexing does not imply the priority of one element, parameter or criterion over another and such denominations may be easily interchanged without departing from the scope of the present description. This indexing also does not imply an order in time, for example, for assessing this or that criterion.

FIG. 1 shows a side view of a flexible electrically conductive strip 2 and of a metal electrical connector 1. The flexible electrically conductive strip 2 extends, more particularly, along a longitudinal axis A (which is visible in FIGS. 2 and 3) and comprises:
a flexible support layer 3 comprising a first face and a second face opposite the first face, and
a conductive path 4 arranged on the first face of the flexible support layer 3.

The support layer 3 may, for its part, be made from a flexible electrically non-conductive material, for example from a plastic material. The support layer 3 may, for example, have a thickness less than or equal to 1 mm.

The conductive strip 2 may be a conductive strip for a surface radiant panel in order, for example, to allow heating within a motor vehicle, in particular in the passenger compartment thereof. This conductive strip 2 may, in particular, be configured to achieve high power levels, that is to say, for example, higher than or equal to 500 W/m². The conductive strip 2 may, in particular, be configured to withstand currents of the order of 15 A and a voltage of the order of 12 V or even 48 V depending on the supply voltage within the motor vehicle.

In the context of a surface radiant panel, the conductive path 4 may, more particularly, be a conductive ink arranged on the first face of the support layer 3. The conductive path 4 may have a thickness less than or equal to 100 μm, for example less than or equal to 60 μm. The conductive path 4 may also have a large width, for example larger than 5 mm or even larger than 10 mm, in order to allow satisfactory heating.

The electrical connector 1 is, for its part, made of an electrically conductive metal material such as, for example, aluminum or aluminum alloy. The electrical connector 1 comprises, in particular:
a base 10 having a generally parallelepipedal shape (which is visible in FIG. 2) and configured to cover a portion of the conductive strip 2, the base 10 comprising at least one leading edge 101 intended to face the conductive strip 2 substantially perpendicular to the longitudinal axis A,
connecting teeth 12a, 12b configured to pass through the conductive path 4 and the flexible support layer 3 as illustrated in FIG. 1, and
a connecting member 11 projecting from one of the edges of the base 10 other than the leading edge 101.

This connecting member 11 allows a connection to be made with a plug or socket which is, for example, crimped onto said connecting member 11. This then allows the electrical connector 1 to be connected to a complementary plug or socket which is, for example, crimped onto an electrical cable.

The electrical connector 1 is preferably made in a single piece, for example by stamping or cutting. The base 10, the connecting teeth 12a, 12b and the connecting member 11 may thus all be formed in one and the same manufacturing step. The electrical connector 1 may, in particular, have a thickness less than or equal to 0.5 mm, preferably of the order of 0.3 mm.

This low thickness of the electrical connector 1 makes it possible to limit the overthickness at the connection with the conductive strip 2 and thus makes it possible to maintain good haptic qualities of the conductive strip 2. What is meant here by good haptic qualities is that the thickness at the connection between the conductive strip 2 and the electrical connector 1 is low enough to be barely perceptible to the touch. This thickness may thus be, in particular, less than 400 μm.

Preferably, the base 10 is arranged on the first face of the support layer 3 and covers the conductive path 4.

The leading edge 101 of the base 10 has a profile that is curved over the width of said base 10. This curved profile makes it possible to limit the risk of breaks and cracks forming within the conductive path perpendicular to the longitudinal axis A of the conductive strip 2 and therefore perpendicular to the direction in which the current flows. This is particularly advantageous for wide conductive paths 4, that is to say, for example, of a width greater than 5 mm or even greater than 10 mm.

In the example illustrated in FIG. 2, the leading edge 101 comprises a single portion which is concave over its entire width.

For the same reasons, the junction between the edges 102 of the base 10 which are contiguous with the leading edge 101 and said leading edge 101 is rounded. Specifically, limiting sharp angles makes it possible to limit the risk of breaks and cracks forming within the conductive path 4 perpendicular to the longitudinal axis A.

The electrical connector 1 comprises, in particular, first connecting teeth 12a, the base of which is intended to be arranged parallel to the longitudinal axis A of the conductive strip 2. The fact that the base of these first connecting teeth 12a is parallel to the longitudinal axis A of the conductive strip 2 makes it possible for the resistance of the conductive path 4 not to be modified, or to be modified only slightly. Specifically, if the material forming the conductive path 4 is particularly rigid, said conductive path 4 being perforated by the connecting teeth 12a, 12b may create breaks or cracks. If these breaks or cracks were to be arranged in the direction of the current, that is to say parallel to the longitudinal axis A, this would generate a local discontinuity in the conductive path 4 and therefore a local reduction in the area through which the current flows. This local reduction in the area through which the current flows may lead to a higher electrical resistance locally and therefore to a hot spot forming.

Still in order to limit the risk of hot spots forming, the base 10 covers at least 90% of the width of the conductive path 4 and the edges 102 of the base 10 which are contiguous with the leading edge 101 each comprise at least one first connecting tooth 12a. Thus, the electric current is better distributed over the width of the conductive path 4 and the risk of hot spots forming is reduced.

As illustrated in FIGS. 2 and 3, the electrical connector 1 may also comprise second connecting teeth 12b in smaller numbers than the first connecting teeth 12a. The base of these second connecting teeth 12b is intended to be arranged perpendicular to the longitudinal axis A of the conductive strip 2. The role of these second connecting teeth 12b is here mechanical strength and keeping the electrical connector 1 on the conductive strip 2.

As shown in FIG. 3, the first 12a and second 12b connecting teeth are bent, preferably inward, here over the second face of the support layer 2, in order to increase the contact force between the electrical connector 1 and the conductive strip 2 and secure the electrical connection.

The number of first 12a and second 12b connecting teeth is, more particularly, variable depending on the size of the electrical connector 1 and the width of the conductive path 4. The wider the conductive path 4 and the larger the electrical connector 1, the greater the number of connecting teeth 12a, 12b.

In the example illustrated in FIGS. 2 and 3, the electrical connector 1 comprises, in particular, two first connecting teeth 12a arranged on each edge 102 of the base 10 which is contiguous with the leading edge 101. The electrical connector 1 also comprises two other first connecting teeth 12a arranged on its base 10 within openings 13, for example made by stamping or cutting.

Still in the example illustrated in FIGS. 2 and 3, the electrical connector 1 comprises two second connecting teeth 12b arranged on the edge 103 of the base 10 which is opposite the leading edge 101. These two second connecting teeth 12b are, in particular, arranged on either side of the connecting member 11.

In the example illustrated in FIGS. 1 to 3, the electrical connector 1 is arranged on the conductive strip so that its base 10 is in direct contact with the conductive path 4. The first connecting teeth 12a and the second connecting teeth 12b then consecutively pass through the conductive path 4 and the support layer 3. These first connecting teeth 12a and these second connecting teeth 12b are then bent over the second face of the support layer 3, which is opposite its first face comprising the conductive path 4. This embodiment makes it possible to have a large contact area between the electrical connector 1 and the conductive path 4.

According to another embodiment, illustrated in FIG. 4, the electrical connector 1 is arranged on the conductive strip so that its base 10 is in contact with the second face of the support layer 3, which is opposite its first face comprising the conductive path 4. The first connecting teeth 12a and the second connecting teeth 12b then consecutively pass through the support layer 3 and the conductive path 4. These first connecting teeth 12a and these second connecting teeth 12b are then bent over the conductive path 4. This embodiment makes it possible to secure the electrical contact, which is here made mainly at the first connecting teeth 12a.

FIG. 5 shows an electrical connector 1 according to another embodiment. In this embodiment, the leading edge 101 comprises a plurality of alternating convex and concave portions in order to limit the risk of breaks and cracks forming.

The electrical connector 1, or rather its base 10, may exhibit increasing flexibility with decreasing distance from the leading edge 101. This allows the movements of the conductive strip 2 to be followed and thus the risk of breaks and cracks forming at the leading edge 101 to be limited even more.

For this purpose, as illustrated in FIG. 5, the base 10 may comprise perforations 15, the concentration of which increases with decreasing distance from the leading edge 101. These perforations 15 may, in particular, be slots of identical shape to the leading edge 101 and parallel to said leading edge 101.

Still with the aim of limiting the risk of breaks and cracks forming at the leading edge 101, another solution, illustrated in FIG. 6, is to arrange an additional flexible layer 5 between the base 10 of the electrical connector 1 and the conductive strip 2. More specifically, the additional layer 5 is arranged between the base 10 of the electrical connector 1 and the second face of the support layer 3, which is opposite its first face comprising the conductive path 4. In the same way as the conductive strip 2, this additional layer 5 is pierced through by the connecting teeth 12a, 12b.

This additional layer 5 exhibits lower flexibility than the conductive strip 2 and projects beyond the leading edge 101. Due to its flexibility being lower than that of the conductive strip 2, this additional layer 5 will attenuate the movements of the conductive strip 2 and limit the risk of breaks and cracks forming at the leading edge 101.

The additional layer 5 may, for example, be made of an electrically non-conductive material such as, for example, a plastic film. This additional layer 5 may, in particular, have a low thickness in order not to degrade the haptic qualities of the conductive strip 2. The additional layer 5 may thus have a thickness less than or equal to 200 μm.

Thus, it may be clearly seen that, by virtue of its structure, the electrical connector 1 makes it possible to limit the risk of hot spots forming at the electrical connection with the conductive path 4 and the risk of breaks and cracks forming in this same conductive path 4, which might be detrimental to electrical conductivity, in particular for conductive strips 2 intended to receive high currents and voltages. In addition, the structure of the electrical connector 1 makes it possible to limit an overthickness being formed at the electrical connection.

1. A metal electrical connector for a flexible electrically conductive strip extending along a longitudinal axis, said conductive strip comprising:
a flexible support layer comprising a first face and a second face opposite the first face, and
a conductive path arranged on the first face of the flexible support layer,
the metal electrical connector comprising:
a base having a generally parallelepipedal shape and configured to cover a portion of the conductive strip, said base comprising at least one leading edge configured to face said conductive strip perpendicular to the longitudinal axis;
connecting teeth configured to pass through the conductive path and the flexible support layer; and
a connecting member projecting from one of the edges of the base other than the leading edge,
wherein the leading edge of the base has a profile that is curved over the width of said base.

2. The electrical connector as claimed in claim 1, wherein the base exhibits increasing flexibility with decreasing distance from the leading edge.

3. The electrical connector as claimed in claim 2, wherein the base comprises perforations, the concentration of which increases with decreasing distance from the leading edge.

4. The electrical connector as claimed in claim 3, wherein the perforations are slots of identical shape to the leading edge and are parallel to said leading edge.

5. The electrical connector as claimed in claim 1, wherein the junction between the edges of the base which are contiguous with the leading edge and said leading edge is rounded.

6. The electrical connector as claimed in claim 1, further comprising: first connecting teeth, the base of which is configured to be arranged parallel to the longitudinal axis of the conductive strip.

7. The electrical connector as claimed in claim 6, wherein the base covers at least 90% of the width of the conductive path and the edges of the base which are contiguous with the leading edge each comprise at least one first connecting tooth.

8. The electrical connector as claimed in claim 1, further comprising: second connecting teeth in smaller numbers than the first connecting teeth, and the base of which is intended to be arranged perpendicular to the longitudinal axis of the conductive strip.

9. An assembly comprising:
a flexible electrically conductive strip extending along a longitudinal axis, said conductive strip comprising a flexible support layer comprising a first face and a second face opposite the first face, and a conductive path arranged on the first face of the flexible support layer; and
an electrical connector as claimed in claim 1, the connecting teeth of which pierce through the support layer and the conductive path of said support layer.

10. The assembly as claimed in claim 9, wherein an additional flexible layer is arranged between the base of the electrical connector and said conductive strip, the additional flexible layer projecting beyond the leading edge of the electrical connector and being pierced through by the connecting teeth, said additional flexible layer having a flexibility lower than that of the conductive strip.
